(19) United States
(12) Patent Application Publication
(10) Pub. No.: US 2006/0213068 A1
(43) Pub. Date: Sep. 28, 2006

(54) MASSAGE DEVICE

(76) Inventor: KO-PO CHEN, Taichung (TW)

Correspondence Address: LAW OFFICE OF LIAUH & ASSOC., 4224 WAIALAE AVE, STE 5-388, HONOLULU, HI, 96816, US

(21) Appl. No.: 10/907,237

(22) Filed: Mar. 24, 2005

(51) Int. Cl. B27B 21/06

(52) U.S. Cl. 30/513

(57) ABSTRACT

Provided is a hacksaw comprising a front cavity in a tang of the frame, a resilient member having one end fastened in one side of the cavity, a handle for receiving the tang and a top opening aligned with the cavity, a pivotal lock lever disposed in the opening and comprising an arm and an end urging member (e.g., cam), a blade inserted through the cavity and the tang into the handle. A thin portion of the urging member is disposed proximate the resilient member and the resilient member is disengaged from the blade when the arm is disposed in a forward position. To the contrary, a thick portion of the urging member is pressed down on the resilient member for fastening a back of the blade when the arm is disposed in a rearward position.

### BACKGROUND OF THE INVENTION

1. Field of Invention

The present invention relates to hacksaws and more particularly to an improved mechanism for locking an adjustable blade of hacksaw.

2. Related Art

Hacksaws with adjustable blade are well known. For example, Taiwanese Patent No. 91,204,426 discloses a mechanism for locking an adjustable blade 4 of hacksaw as shown in FIGS. 1 and 2. A guide groove 11 is provided in a toe of the frame with a forward portion of the blade 4 passed through (see FIG. 2). A cavity 13 is provided in the front portion of a handle 1. An upward directed channel 14 is provided for communicating a top of the cavity 13 with the external. A curved recess 15 is formed on a top surface of the handle 1 with an opening of the channel 14 disposed on its bottom. A sliding member 2 is disposed in the cavity 13. The sliding member 2 comprises a transverse hollow portion 21 as a part of a tunnel 12 in the handle 1 with a portion of the blade 4 passed through, and a top projection 22 protruded through the channel 14 in the recess 15, the projection 22 having an aperture 23 in its open end. A pivotal lock member 3 comprises a curved body 31 having its outer surface 33 snugly fitted on the recess 15 and a hole (not numbered) with an upper portion of the projection 22 fitted therein, a bore 32 aligned with the aperture 23, and a shaft 32 loosely fitted in the bore 32 and the aperture 23 such that the lock member 3 is able to pivot about the sliding member 2 as detailed below.

In operation, after placing the blade 4 in the handle 1 and being held by the frame with a desired length of the blade 4 exposed from the handle 1, a user may push the lock member 3 forward from the position of FIG. 1 to the position of FIG. 2. The projection 22 thus lifts to its upper limit. The blade 4 is substantially in a horizontal position with a portion of its back urged against a top of the guide groove 11. In the position shown in FIG. 2, the blade 4 is fastened.

However, the prior art suffered from several disadvantages. For example, the locking mechanism is typically relatively complex in components resulting in an increase in the manufacturing cost, unreliable in use, and troublesome to manipulate or operate. Thus, the need for improvement still exists.

### SUMMARY OF THE INVENTION

It is therefore an object of the present invention to provide a hacksaw having a mechanism for locking an adjustable blade thereof.

The above and other objects of the present invention are realized by providing a hacksaw comprising a frame comprising a guide groove provided in its toe, a front cavity provided in its tang and being in communication with the external, and a rear tunnel being in communication with the cavity and a rear end of the frame; a resilient member having one end fastened in one side of the cavity; a handle comprising an internal space for receiving the tang of the frame and a top opening aligned with the cavity; a pivotal lock lever comprising an arm, an urging member provided at one end, and a pin inserted through the handle and the cam for pivotably disposing the lock lever in the opening; and a blade having a forward portion passed through the guide groove and fastened therein, and remaining portion releasably inserted through the cavity and the tunnel into the space of the handle, wherein a thin portion of the urging member is disposed proximate the resilient member and the resilient member is disengaged from the blade when the arm is disposed in a forward position by pivoting about the pin, and wherein a thick portion of the urging member is pressed down on the resilient member for fastening a back of the blade when the arm is disposed in a rearward position by pivoting about the pin.

In one aspect of the present invention, the urging member is a cam.

In another aspect of the present invention, the urging member is a member having a substantially rounded periphery in more that half of its surface.

In yet another aspect of the present invention, the resilient member comprises a curved intermediate portion and two flat ends.

In a further aspect of the present invention, there is further provided a slit in one side of the cavity with one end of the resilient member fastened therein.

The above and other objects, features and advantages of the present invention will become apparent from the following detailed description taken with the accompanying drawings.

### BRIEF DESCRIPTION OF THE DRAWINGS

FIG. 1 is a lengthwise sectional view of a prior art hacksaw having a mechanism for locking an adjustable blade thereof, where the blade has not been fastened;

FIG. 2 is a view similar to FIG. 1, where the blade has been fastened by pushing the lock member forward;

FIG. 3 is an exploded view of a hacksaw having a mechanism for locking an adjustable blade thereof according to the invention;

FIG. 4 is a perspective view of the assembled hacksaw of FIG. 3;

FIG. 5 is a side view in part section of the hacksaw of FIG. 4, where the blade has not been fastened;

FIG. 6 is a detailed view of the lock lever and the handle in FIG. 5, where the blade is moving for length adjustment;

FIG. 7 is a view similar to FIG. 6, where the blade has been fastened by pushing the lock lever rearward;

FIG. 8 is a view similar to FIG. 6 for showing lock lever of a second preferred embodiment according to the invention; and

FIG. 9 is a view similar to FIG. 7, where the blade has been fastened by pushing the lock lever of the FIG. 8 rearward.

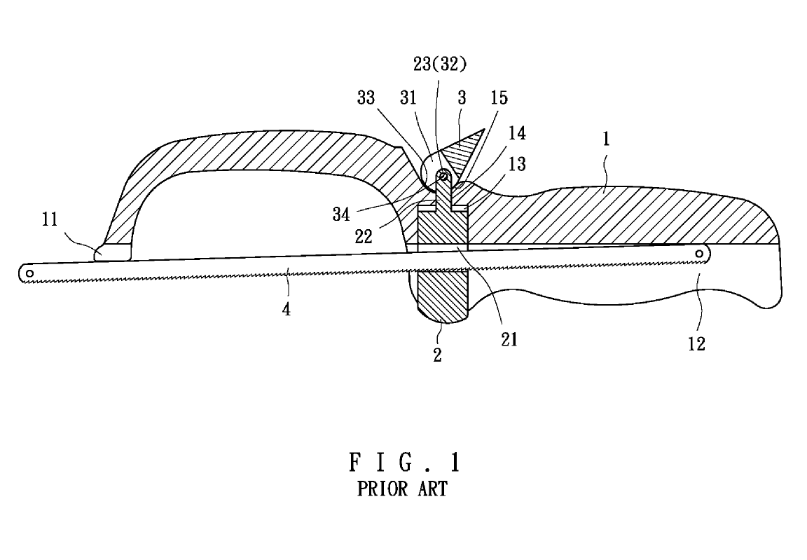

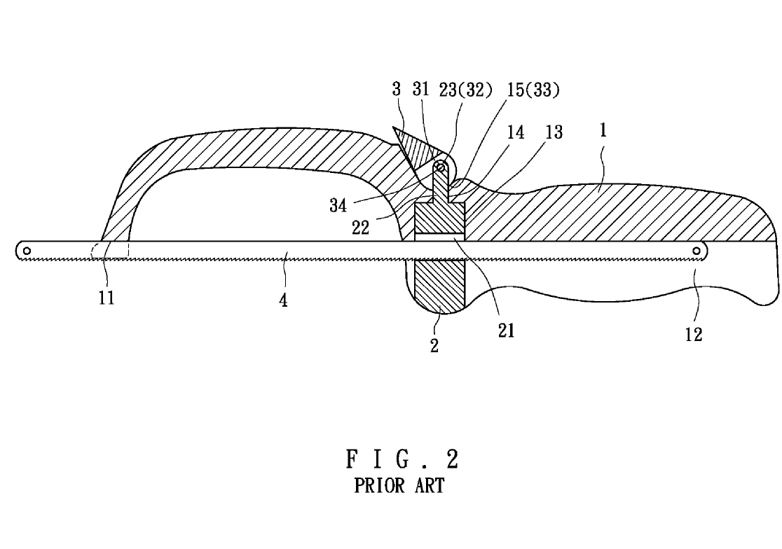

### DETAILED DESCRIPTION OF THE INVENTION

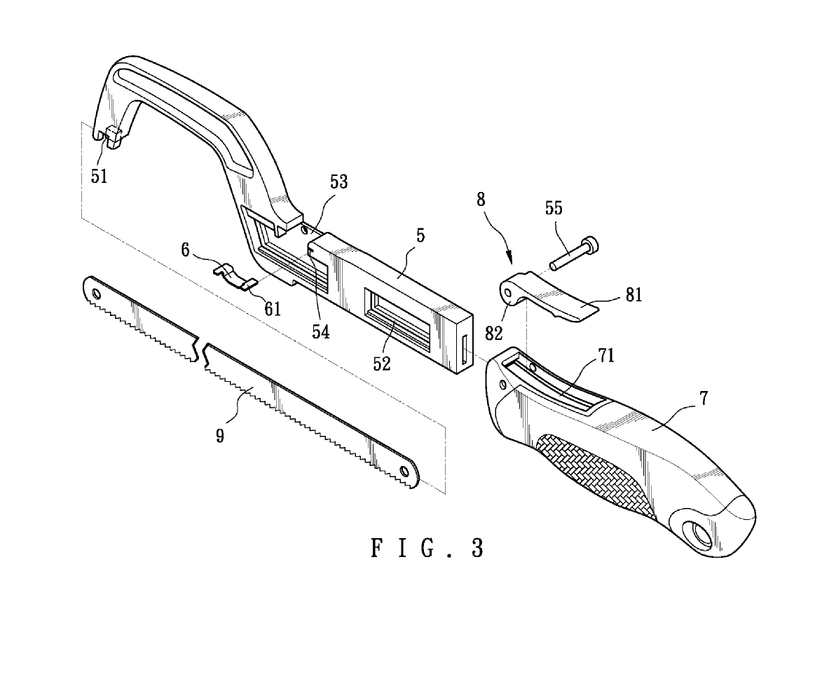

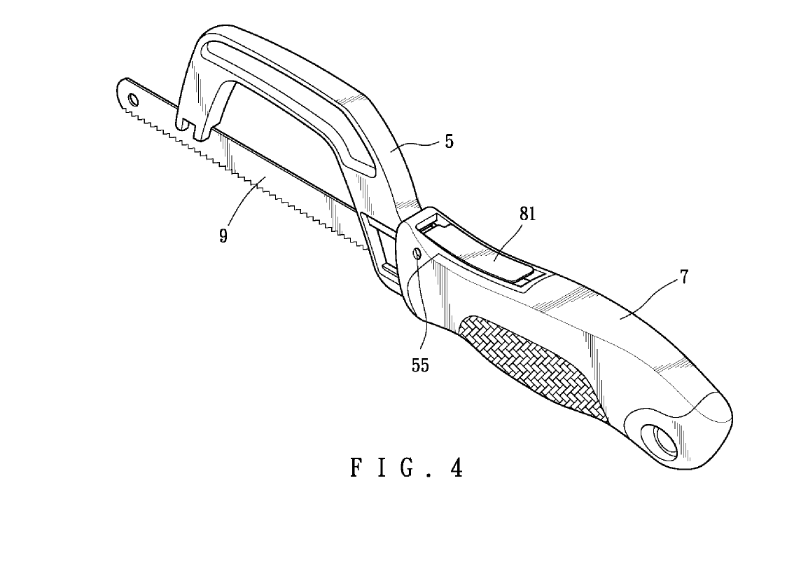

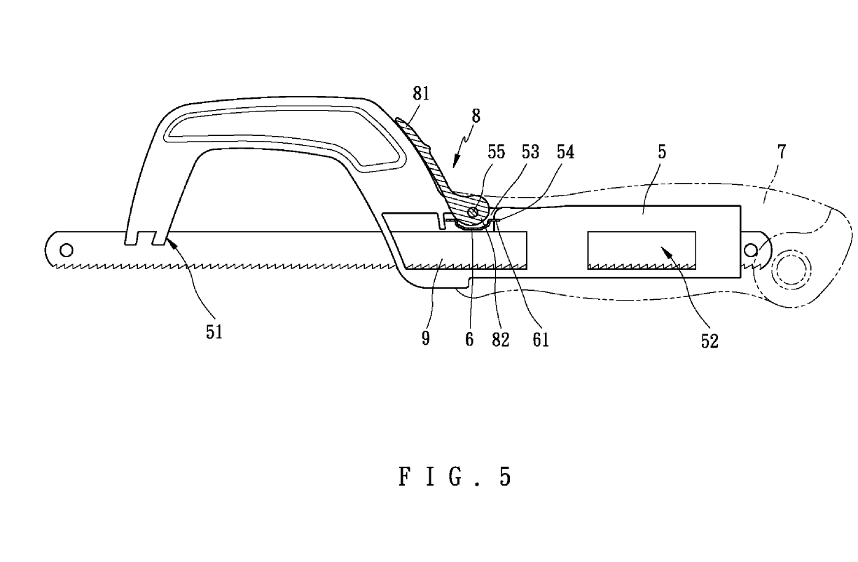

Referring to FIGS. 3, 4, and 5, there is shown a hacksaw having a mechanism for locking an adjustable blade thereof in accordance with the invention. A guide groove 51 is provided in a toe of the frame 5 with a forward portion of the blade 9 passed through and fastened therein. A front first cavity 53 is provided in a heel of the frame 5 and a rear second cavity 52 is provided in a tang portion thereof in which both the cavities 52 and 53 are in communication, a front end of the first cavity 53 is in communication with the external, and a rear end of the second cavity 52 is also open. A slit 54 is provided in one side of a narrow upper opening of the first cavity 53. A curved resilient member 6 has two flat ends 61 in which one end 61 is snugly inserted into the slit 54 for fastening and the remaining portion is provided in the first cavity 53. The tang portion of the frame 5 is provided in a handle 7. The handle 7 comprises a rectangular opening 71 on its top surface. The opening 71 is aligned with the first cavity 53. A pivotal lock lever 8 comprises an elongated arm 81 and a cam 82 at one end. A pin 55 is driven through one aperture at one side of the opening 71, one wall of the first cavity 53, and an aperture of the cam 82 into the other opposite aperture at the other side of the opening 71 for pivotably disposing the lock lever 8 in the opening 71 in which a thin portion of the cam 82 is disposed proximate the curved intermediate portion of the resilient member 6 when the arm 81 is pushed forward by pivoting about the pin 55. A portion of the blade 9 is adapted to either insert through the cavities 53 and 52 into a rear portion of an internal space of the handle 7 for use or withdraw therefrom for replacement.

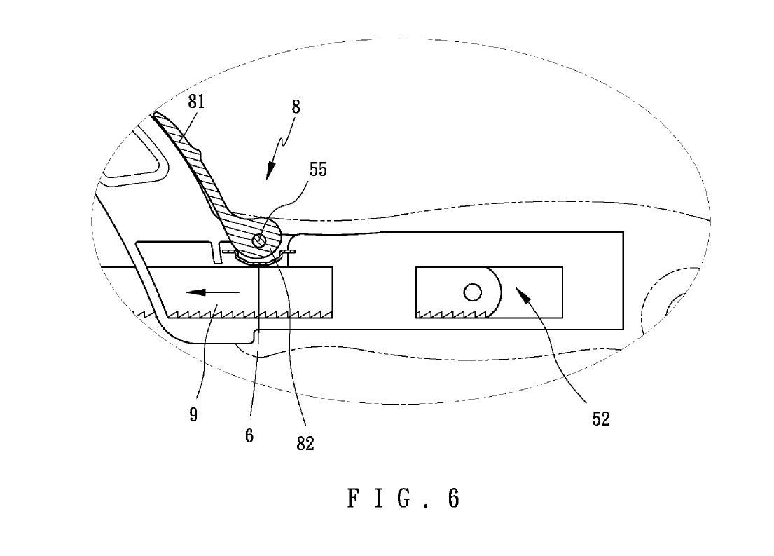

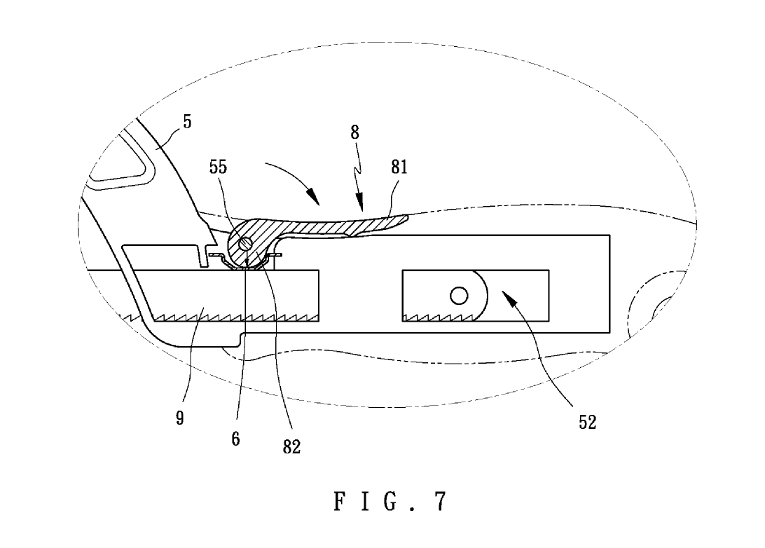

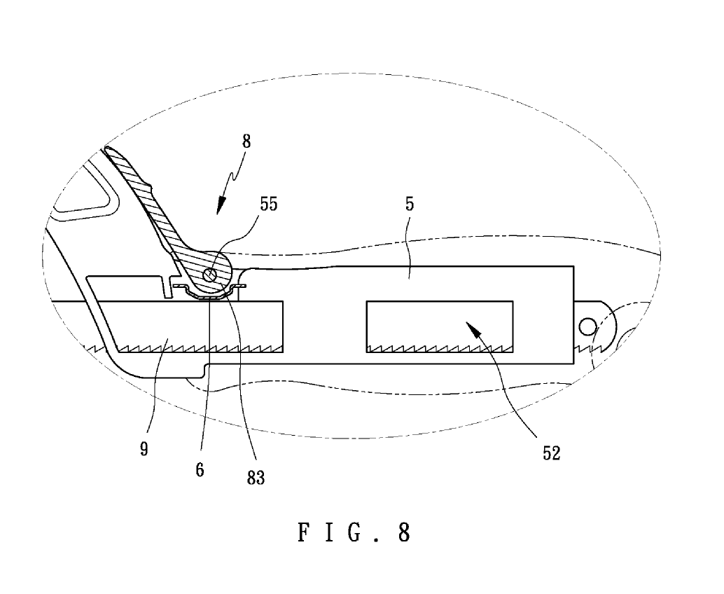

Referring to FIGS. 6 and 7, the thin portion of the cam 82 is disposed proximate the curved intermediate portion of the resilient member 6 when the arm 81 is pushed forward. In this position, a user may slide the blade 9 to adjust its length. Once the length has been adjusted, the user may push the lock lever 8 rearward to cause a thick portion of the cam 82 to push down and flatten the intermediate portion of the resilient member 6. As such, the back of the blade 9 is urged by the large, intermediate portion of the resilient member 6 (i.e., increased contact area). In this position, the blade 9 is fastened and is ready to cut an object. For unfastening the blade 9, the steps discussed with reference to FIGS. 6 and 7 are traversed in the opposite direction.

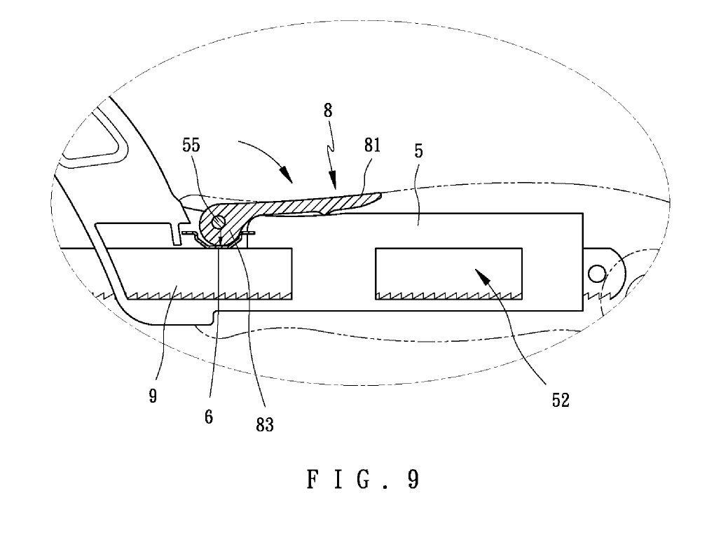

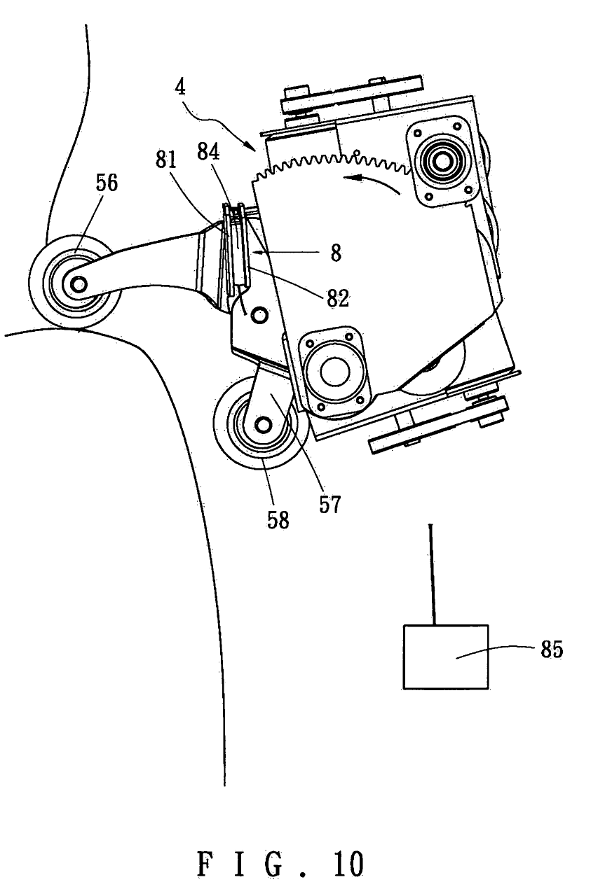

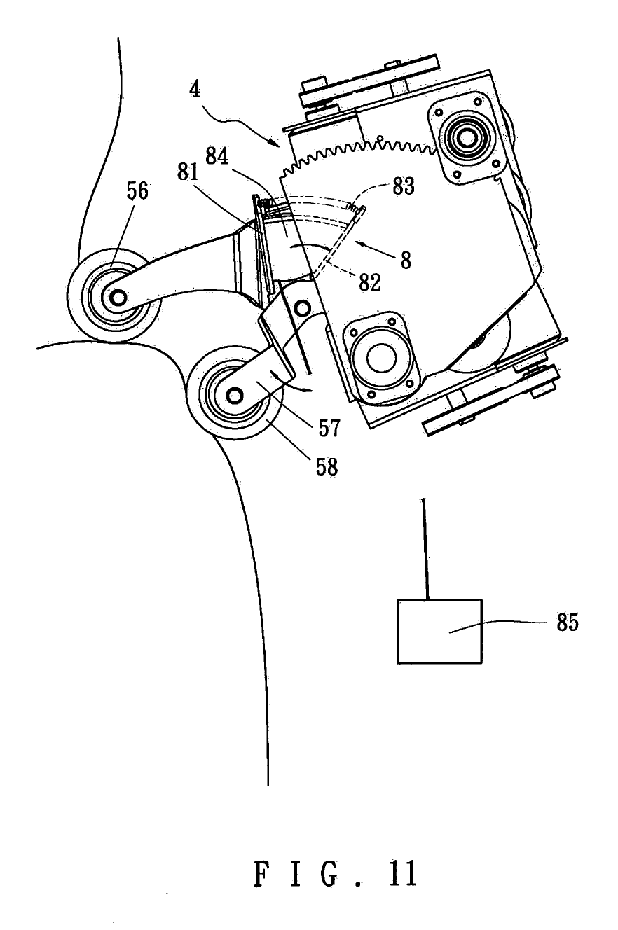

Referring to FIGS. 8 and 9, a second preferred embodiment of lock lever 8 according to the invention is shown. The characteristic of the second preferred embodiment is that the cam 82 is replaced by one member 83 having a substantially rounded periphery in more that half of its surface. Its operations are generally identical to that described above. Accordingly, further description is omitted for purpose of brevity.

While the invention herein disclosed has been described by means of specific embodiments, numerous modifications and variations could be made thereto by those skilled in the art without departing from the scope and spirit of the invention set forth in the claims.

What is claimed is:

1. A hacksaw comprising:
a frame comprising a guide groove provided in its toe, a front cavity provided in its tang and being in communication with the external, and a rear tunnel being in communication with the cavity and a rear end of the frame;
a resilient member having one end fastened in one side of the cavity;
a handle comprising an internal space for receiving the tang of the frame and a top opening aligned with the cavity;
a pivotal lock lever comprising an arm, an urging member provided at one end, and a pin inserted through the handle and the cam for pivotably disposing the lock lever in the opening; and
a blade having a forward portion passed through the guide groove and fastened therein, and remaining portion releasably inserted through the cavity and the tunnel into the space of the handle,
wherein a thin portion of the urging member is disposed proximate the resilient member and the resilient member is disengaged from the blade when the arm is disposed in a forward position by pivoting about the pin, and wherein a thick portion of the urging member is pressed down on the resilient member for fastening a back of the blade when the arm is disposed in a rearward position by pivoting about the pin.

2. The hacksaw of claim 1, wherein the urging member is a cam.

3. The hacksaw of claim 1, wherein the urging member is a member having a substantially rounded periphery in more that half of its surface.

4. The hacksaw of claim 1, wherein the resilient member comprises a curved intermediate portion and two flat ends.

5. The hacksaw of claim 4, further comprising a slit provided in one side of the cavity with one end of the resilient member fastened therein.
